(19) United States
(12) Patent Application Publication
(10) Pub. No.: US 2007/0074274 A1
(43) Pub. Date: Mar. 29, 2007

(54) Network communications protocol

(76) Inventor: Matt Nowicki, Leander, TX (US)

Correspondence Address: DAVID G. HENRY, 900 Washington Ave., P.O. Box 1470, Waco, TX, 76703-1470, US

(21) Appl. No.: 11/193,000

(22) Filed: Jul. 29, 2005

Related U.S. Application Data
(60) Provisional application No. 60/592,340, filed on Jul. 29, 2004.

(51) Int. Cl. H04L 9/32

(52) U.S. Cl. 726/4

(57) ABSTRACT

A network communications process may comprise establishing communication between a service user and a service provider, soliciting and in response transmitting user name and password information, and in response substantially matching records of passwords and associated user names in records of the service provider, transmitting by the service user identifying data which corresponds to a specific data record reflective at least of video-based information and stored on the service provider's computer, and conditioned upon the submission of the specific data which substantially matches identifying information for the specific data record stored on the service provider's computer, configuring the data record for communication and actuation of video player software means operable through use of the service user's computer.

### PRIORITY DATA

This Application claims priority, pursuant to 35 U.S.C. 119(e), from U.S. Provisional Patent Application No. 60/592,340, filed 29 Jul. 2004.

### FIELD OF THE INVENTION

The present invention relates to communications protocols, useful in computer-to-computer communicaitons over networks, the internet in particular.

### DESCRIPTION OF THE INVENTION

The new protocol (assigned the SENIP [SMARTEYE NET INTERNET PROTOCOL], port 3898 designation by the Internet Assigned Numbers Authority [“IANA”]) affords enhanced security in data transfers. This, in turn, not only meets the goal of virtually every computer network user for confidentiality for confidentiality's own sake, but in the case of commercial and finance-related entities' communications which include their customers' confidential information, enhances their ability to comply with legal duties pertaining to confidentiality, such as under the Gramm-Leach-Bliley Act (15 U.S.C. §§ 6801 et seq.). The SENIP protocol command summary follows as APPENDIX A and an Algorithmic Description is attached as Appendix B. The protocol of the present invention is presently used in a context in which necessarily limited access to certain sensitive video-based and other data is involved. The service at issue (operated by the present inventor's assignee—Innovative Aftermarket Systems, LLC of Leander, Texas [“IAS”]) is known as SMARTEYE.NET and involves the use, by end users, of a software program called SMARTEYE, which, among other things, records, stores and uploads audio/video records of business transactions for later viewing in the context of possible evidentiary use.

The following is a discussion which aids in a useful application of the present protocol in the context of IAS' SMARTEYE.NET service:

### General Protocol and Firewall Information

A firewall is a piece of hardware or software that prevents data packets from either entering or leaving a specified network. To control the flow of traffic, numbered ports in the firewall are either opened or closed to types of packets. The firewall looks at two pieces of information in each arriving or departing packet: the protocol through which the packet is being delivered, and the port number to which it is being sent. If the firewall is configured to accept the specified protocol through the targeted port, the packet is allowed through. SMARTEYE incorporates a component of Windows Media Player for the playback of files. It also uses a proprietary protocol to communicate back and forth with the server. Because SMARTEYE incorporates components of Windows Media Player and this proprietary protocol, some firewall configuration be necessary in order for the software to function properly.

### Sockets, the SMARTEYE NET Protocol, and Firewalls

SMARTEYE communicates back and forth with SMARTEYE.NET using a proprietary protocol which has been assigned the to the TCP port numbered 3898. This port number assignment was made by the Internet Assigned Numbers Authority (IANA) in October 2003. To verify, search for the “senip” protocol here. This “senip” protocol, which is very similar to HTTP or FTP, operates over a “socket”, which is an end to end connection between two computers. Before describing the firewall setup, it is important to understand one thing about sockets: the difference between source ports and destination ports. SMARTEYE NET is open for connections to port 3898. So for a SMARTEYE client, the destination port is always 3898. The source port, on the other hand, is not a static number. When a socket connection is established, the socket searches for an open port on the local TCP/IP stack. Note that only one program can use a single port at one time (fortunately there are 65,536 TCP/IP ports on every Windows system). Depending on what is running on the local machine, various source ports might be in use. What might at first seem strange is that the source port will almost never be port 3898. To understand why this is the case, consider this analogy to HTTP. If a user went to a Windows 2000 Server which was hosting web pages (on port 80), that user would definitely be able to surf other pages on the Internet. If the source port of the HTTP socket had to be port 80, there would be two programs (Internet Explorer and IIS in this example) attempting to use the same port. Because of this, your firewall should be configured to allow any inside source/host TCP port while allowing at least TCP port 3898 as a destination.

To allow SMARTEYE users to communicate with SMARTEYE NET, the SMARTEYE client must be able to go out to a remote server (Destination Port) using TCP port 3898. If an entry exists in the firewall for HTTP/port 80, this entry could be duplicated and changed to port 3898 instead as the two protocols are very similar.

SMARTEYE.NET also includes an Internet interface. This interface is also encrypted using industry standard SSL encryption. As a result, any user needing access to www.mySMARTEYE.com will need to permission to go out to a remote server (Destination Port) using TCP port 443.

### Windows Media and Firewalls

Windows Media is able to receive media broadcasts through either UDP or TCP connections. For Windows Media content, UDP is preferred as it is a more efficient connection for video. UDP does require more ports to be opened however. TCP is less efficient, but also requires only a single open port.

To allow SMARTEYE users to stream video using UDP connections, the SMARTEYE client must be able to go out to a remote server using TCP port 1755 and UDP port 1755. The remote server must be able to communicate back in to the client using UDP ports between 1024 and 5000. It is only necessary to open as many UDP ports as there are clients. So if there will only be a maximum of ten clients connecting at once to SMARTEYE NET, the only ports necessary are UDP ports 1024-1033 To allow SMARTEYE users to stream video using TCP connections only, the SMARTEYE client must be able to go out to a remote server using TCP port 1755. The remote server must be able to communicate back in to the client using TCP port 1755.

Use of the disclosed protocol enables security-enhanced network communications unmatched with alternatively available protocols.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A network communications process comprising the steps of:
through operation of two or more computer means:
establishing communication between a service user and a service provider;
soliciting and in response transmitting user name and password information, and in response to the submission of said user name and password information substantially matching records of passwords and associated user names in records of said service provider, facilitating further data interchange between said two or more computer means;
transmitting by said service user identifying data which corresponds to a specific data record reflective at least of video-based information and stored on said service provider's computer means, and conditioned upon the submission of said specific data which substantially matches identifying information for a said specific data record stored on said service provider's computer means, configuring said data record for communication and actuation of video player software means operable through use of said service user's computer means.

2. A network communications process comprising the steps of:
through operation of two or more computer means:
establishing communication between a service user and a service provider;
soliciting and in response transmitting user name and password information, respectively between said service provider and said service user, and in response to the submission of said user name and password information substantially matching records of passwords and associated user names in records of said service provider, facilitating further data interchange between said two or more computer means;
transmitting by said service user a request for uploading a data record reflective at least of video-based information, and in response thereto, transmitting by said service provider's computer means, an indication of a ready state for receiving an upload of said data record;
transmitting by said service user identifying information through later observation of which, said data record is identifiable.
configuring by said service user's computer means of said data record for uploading to said service provider's computer means and uploading same to said service provider's computer means;
through operation of said service provider's computer means, storing said data record in association with said identifying information in a manner for later location and access to said data record.

3. A network communications process comprising the steps of:
through operation of two or more computer means:
establishing communication between a service user and a service provider;
soliciting and in response transmitting user name and password information, and in response to the submission of said user name and password information substantially matching records of passwords and associated user names in records of said service provider, facilitating further data interchange between said two or more computer means;
transmitting by said service user identifying data which corresponds to a specific data record reflective at least of video-based information and stored on said service provider's computer means, and conditioned upon the submission of said specific data which substantially matches identifying information for a said specific data record stored on said service provider's computer means, configuring said data record for communication and actuation of video player software means operable through use of said service user's computer means;
transmitting by said service user a request for uploading a data record reflective at least of video-based information, and in response thereto, transmitting by said service provider's computer means, an indication of a ready state for receiving an upload of said data record;
transmitting by said service user identifying information through later observation of which, said data record is identifiable;
configuring by said service user's computer means of said data record for uploading to said service provider's computer means and uploading same to said service provider's computer means; and
through operation of said service provider's computer means, storing said data record in association with said identifying information in a manner for later location and access to said data record.
